(19) United States
(12) Patent Application Publication
(10) Pub. No.: US 2026/0100423 A1
(43) Pub. Date: Apr. 9, 2026

(54) Hypogeal Battery Using Sandy Al-Ion Rechargeable Cells

(71) Applicant: Olurinde Ebenezer Lafe, Bentleyville, OH (US)

(72) Inventor: Olurinde Ebenezer Lafe, Bentleyville, OH (US)

(73) Assignee: Fuel Cells Global LTD, Bentleyville, OH (US)

(21) Appl. No.: 18/907,584

(22) Filed: Oct. 6, 2024

(51) Int. Cl. H01M 10/38; H01M 4/38; H01M 4/587; H01M 4/66; H01M 50/213; H01M 50/251; H01M 50/509

(52) U.S. Cl. CPC H01M 10/38; H01M 4/38; H01M 4/587; H01M 4/661; H01M 4/667; H01M 50/213; H01M 50/251; H01M 50/509; H01M 2220/10; H01M 2300/0002

(57) ABSTRACT

A method and apparatus for storing electrical energy using ensemble electrochemical cells each comprising a cylindrical exterior container, a coiled anodic aluminum wire, carbon graphite cathode, a sandy electrolyte medium, and an ionic electrolyte based on a compound mixture of urea, sea-salt, and water. The invention teaches the use of inexpensive materials and simple assembling of sandy rechargeable cells into a hypogeal battery.

### REFERENCES

Archer, L., Das, S. & Navaneedhakrishman, 2014. Aluminum Ion Battery Including Metal Sulfide or Monocrystalline Vanadium Oxide Cathode and Ionic Liquid Based Electrolyte. United States of America, Patent No. 20140242457.

Azimi, G. & Ng, K.L., 2023. Aluminum-Ion Battery Using Aluminum Chloride/Trimethylamine Ionic Liquid As Electrolyte. United States of America, Patent No. 20230104025.

Bockstie, L., Trevethan, D. & Zaromb, S., 1963. Control of Al corrosion in caustic solutions. Journal of The Electrochemical Society, 110(4), pp. 267-271.

Caban-Acevado, M. & Yushin, G., 2023. Rechargeable Batteries With Alkali Metal Ion Cathodes, Aluminum Metal-Based Anodes And Displacement Electrolyte. United States of America, Patent No. 20230411595.

Craig, B., Schoetz, T., Cruden, A. & Ponce de Leon, C., 2020. Review of current progress in non-aqueous aluminum batteries. Renewable and Sustainable Energy Reviews, Volume 133.

Das, S.K., Mahapatra, S. & Lahan, H., 2017. Alumnum-ion batteries: developments and challenges. J. Mater. Chem. A, Volume 5, pp. 6347-6367.

Du Yuan, Jin Zhao, William Manalastas Jr., Sonal Kumar, Madhavi Srinivasan, 2020. Emerging rechageable aqueous aluminum ion battery: Status, challenges, and outlooks. Nano Materials Science, pp. 248-263.

Elia, G. et al., 2021. An Overview and Prospective on AI and Al-Ion Battery Technologies. Journal of Power Sources, 481(228870).

Friesen, C.A. & Martinez, J.A. B., 2018. s.l. U.S. Pat. No. 10,090,520.

Friesen, C.A., McDowell, F. & Bautista, M.J. A., 2016. Aluminum-Based Metal-Air Batteries. United States of America, U.S. Pat. No. 9,236,643 B2.

Gan, F. et al., 2019. Low cost ionic liquid electrolytes for rechargeable aluminum/graphite batteries. International Journal of Ionics-The Science and Technology of Ionic Motion, Volume 25, pp. 4243-4249.

Gao, C. & Chen, H., 2018. Preparation Method of Graphene Film Anode Material and Application in Aluminum Ion Battery. United States of America, Patent No. 20190296353.

Giuseppe, Antonio Elia, Kostiantyn V. Kravchyk, Maksym V. Kovalenko, Joaquin Chacon, Alex Holland, Richard G.A. Wills, 2021. An overview and prospective on Al and Al-ion battery technologies. Journal of Power Resources.

Huang, L.-M. & Chen, C.-H., 2018. Aluminum-Ion Battery. United States of America, Patent No. 20180219257.

Leisegang, T. et al., 2019. The Aluminum-Ion Battery: A Sustainable and Seminal Concept?. Front Chem, 7(268).

Levy, N. & Ein-Eli, Y., 2020. Aluminum-ion battery technology: a rising star or a devastating fall?. J Solid State Electrochem, Volume 24, pp. 2067-2071.

Li, C., Zhang, X. & He, W., 2018. Design and modification of cathode materials for high energy density aluminum-ion batteries: a review. J Mater Sci: Mater Electron, Volume 29, pp. 14353-14370.

Miguel, A. et al., 2020. Tough Polymer Gel Electrolytes for Aluminum Secondary Batteries Based on Urea: AlCl3, Prepared by a New Solvent-Free and Scalable Procedure. Polymers, 12(6).

Miller, Y., Tzidon, D. & Yadgar, A., 2021. United States of America, Patent No. 20210075078.

Mori, R., 2020. Recent Developments for Aluminum-Air Batteries. Electrochemical Energy Reviews, Volume 3, pp. 344-369.

Mukherjee, R. & Koratkar, N.A., 2017. Rechargeable Aluminum Ion Battery. United States of America, U.S. Pat. No. 9,819,220 B2.

Mukherjee, R. et al., 2021. Aqueous aluminum ion batteries, hybrid battery-capacitors, compositions of said batteries and battery-capacitors, and associated methods of manufacture and use. United States of America, U.S. Pat. No. 10,978,734 B2.

Niksa, M.J., Niksa, A.J. & Noscal, J.M., 1990. Primary aluminum-air battery. United States of America, U.S. Pat. No. 492,5744.

Pan, W. et al., 2022. Non-aqueous Al-ion batteries: cathode materials and corresponding underlying ion storage mechanisms. Rare Met., Volume 41, pp. 762-774.

Sasaki, K., 2015. United States of America, Patent No. 20150009365.

Stoddart, J., Kim, D., Choi, J. & Yoo, D.-J., 2021. Rechargeable Aluminum Organic Batteries. United States of America, Patent No. 2020242452.

Su, Y.-S. et al., 2020. Aluminum secondary battery having a high-capacity and high-rate capable cathode and manufacturing method. United States of America, Patent No. 20180254512.

Wang, D.-Y. et al., 2017. Advanced rechargeable aluminium ion battery with a high-quality natural graphite cathode. Nature Communications, 8(14283).

Wang, D.-Y. et al., 2017. Advanced Rechargeable Aluminum Ion battery with a High-Quality Natural Graphite Cathode. Nature Communications, Volume 8, p. 14283.

Wang, Y. et al., 2023. Solid-state Al-air battery with an ethanol gel electrolyte. Green Energy & Environment, 8(4), pp. 1117-1127.

Yuan, D. et al., 2020. Emerging rechargeable aqueous aluminum ion battery: Status, challenges, and outlooks. Nano Materials Science, Volume 2, pp. 243-263.

Zaromb, S., 1962. The use and behavior of aluminum anodes in alkaline primary batteries. Journal of The Electrochemical Society, 109(12), pp. 1125-1130.

### FIELD OF INVENTION

The present invention generally relates to electricity generation, and more particularly to a method and apparatus for electrical energy storage using rechargeable aluminum-ion electrochemical cells.

### PRIOR ART

An aluminum-ion battery is a rechargeable battery in which aluminum ions serve as charge carriers. Aluminum-ion batteries consist of electrodes emersed in an electrolyte. The obvious material for the anode is aluminum, an alloy of aluminum, or a compound of aluminum. Common materials for the cathode (Pan, et al., 2022) include: carbon-based materials such as graphite, amorphous carbons, porous carbons (Li, et al., 2018). Common materials for the electrolyte include CO(NH₂)₂ or carbamide (also called urea), sea-salt, and acidic room temperature non-aqueous ionic liquids (IL). The ionic liquid is made of aluminum chloride (AlCl₃) and 1-ethyl-3-methylimidazolium chloride [EmIm]Cl (Miguel, et al., 2020). The use of the ionic liquid as an electrolyte prevents passivation.

Aluminum-ion batteries are promising alternatives to the lithium-ion batteries commonly used in portable electronics, electric vehicles, and stationary energy for homes, commercial buildings, and grid-scale applications. Key advantages of aluminum-ion batteries include the relatively low cost, energy density, safety, and long cycle life (Leisegang, et al., 2019).

Recent investigations on aluminum-ion batteries have been conducted by:
(Wang, et al., 2017) who presented an advanced rechargeable aluminum-ion battery with a high-quality natural graphite cathode.
(Das, et al., 2017) who detailed developments and challenges faced by aluminum-ion batteries. The authors focus on the electrode materials, innovative perspectives, and future research efforts on rechargeable aluminum-ion batteries.
(Gan, et al., 2019) who designed a high-performance rechargeable aluminum battery using a graphite cathode and AlCl₃/Et₃NHCl ionic liquid electrolyte.
(Levy & Ein-Eli, 2020) who discussed the potential of aluminum-ion batteries as a cost-effective energy storage technology for renewable energy sources.
(Craig, et al., 2020) who reviewed current progress in non-aqueous aluminum batteries. The authors conclude that graphite-based positive electrodes, especially cheap and abundant graphite flakes, offer the best overall performance because of the stability and high discharge potential.
(Yuan, et al., 2020) which describes the status, challenges, emerging, and outlooks of emerging rechargeable aqueous aluminum-ion battery.
(Elia, et al., 2021) who reviewed developments in different classes of aluminum-centered batteries. The focus was on “aluminum electrolyte chemistry based on “chloroaluminate melts, deep eutectic solvents, polymers, and chlorine-free formulations.”Patents which taught implementations of the aluminum-ion batteries include:
(Archer, et al., 2014) which teaches an aluminum ion battery using an aluminum anode, a vanadium oxide material cathode, and an ionic liquid electrolyte. The vanadium oxide material cathode comprises a monocrystalline orthorhombic vanadium oxide material.
(Mukherjee & Koratkar, 2017) which describes a rechargeable battery using a solution of an aluminum salt as an electrolyte.
(Huang & Chen, 2018) which describes an aluminum-ion battery using an electrolyte comprising of an aluminum halide, a solvent and a compound made from alkyl or fluoroalkyl group.
(Gao & Chen, 2018) which discloses a method of preparing a graphene anode material by coating a graphene oxide solution on a substrate, drying, removing the substrate, performing reduction, and obtaining a graphene film with ultra-high conductivity.
(Mukherjee, et al., 2021) which describes an aqueous aluminum ion battery with improved charge storage capacity.
(Stoddart, et al., 2021) which discloses rechargeable aluminum batteries using cathodic phenanthrenequinone unit and a graphite flake.
(Azimi & Ng, 2023) which describes aluminum-ion battery technology with an electrolyte consisting of an aluminum trichloride (Al—Cl₃)/trimethylamine hydrochloride ionic liquid, aluminum metal as the anode material, and a compatible cathode active material.
(Su, et al., 2020) which describes an aluminum-ion battery with a cathode comprising of a layer of recompressed exfoliated graphite or carbon material that is oriented in such a manner that the layer has a graphite edge plane in direct contact with the electrolyte and facing the separator.
(Caban-Acevado & Yushin, 2023) which describes rechargeable batteries with alkali metal ion cathodes, aluminum metal-based anodes and displacement electrolyte.

### BACKGROUND OF THE INVENTION

Aluminum-ion batteries are emerging as better alternatives to lithium-ion batteries, the leading choice for wireless devices, computers, electric mobility, and small-scale to grid-scale stationary energy storage applications. The advantages of aluminum-ion batteries over lithium-ion batteries include: cost-effectiveness of aluminum because of its abundance in the Earth's crust; safety because aluminum-ion batteries are less prone to thermal runaway and fire hazards; significantly higher theoretical energy density, 1060 Wh/kg, versus 406 Wh/kg) theoretical limit for lithium-ion batteries; high recyclability of aluminum; longevity due to the large number of charging and discharging cycles of aluminum-ion batteries.

This invention uses the advantages inherent in the electrochemistry of aluminum-ion batteries to teach the construction of an ultra-low-cost solid-state rechargeable battery. The electrodes maximize electrochemical reaction surfaces. The cells are easy to build. The cell components are affordable and widely available materials.

### SUMMARY OF THE INVENTION

According to the present invention there is provided a method of storing electrical energy using ensemble electrochemical cells each comprising a cylindrical exterior container, a coiled anodic aluminum wire, carbon graphite cathode, a sandy electrolyte medium, and an ionic electrolyte based on a compound mixture of urea, sea-salt, and water.

An advantage of the present invention is the provision of a method and apparatus for converting electricity into chemical energy stored in an aluminum-ion cell.

Still another advantage of the present invention is the provision of a method and apparatus for electricity storage which utilizes a sandy electrolyte medium.

Still another advantage of the present invention is the provision of a method and apparatus for electricity storage which utilizes a coiled anodic aluminum wire.

Still another advantage of the present invention is the provision of a method and apparatus for electricity storage which utilizes a folded carbon graphite sheet.

Still another advantage of the present invention is the provision of a method and apparatus for electricity storage which is membrane-free.

Still another advantage of the present invention is the provision of a method and apparatus for electricity generation utilizing sandy tubular cells which are electrically connected and installed below the ground surface to form a hypogeal battery.

Still other advantages of the invention will become apparent to those skilled in the art upon reading and understanding the following detailed description, accompanying drawings and appended claims.

### BRIEF DESCRIPTION OF DRAWINGS

The invention may take physical form in certain parts and arrangements of parts, a preferred embodiment and method of which will be described in detail in this specification and illustrated in the accompanying drawings which form a part hereof, and wherein:

FIG. 1 is an illustration of the isometric view of the Sandy Rechargeable Cell;

FIG. 2 is an illustration of the horizontal cross-section of the Sandy Rechargeable Cell;

FIG. 3 is an illustration of the vertical cross-section of the Sandy Rechargeable Cell;

FIG. 4 is an illustration of the isometric view of Sandy Rechargeable Cells arranged to form the Hypogeal Battery.

FIG. 5 is an illustration of the steps involved in the construction of the Sandy Rechargeable Cell.

FIG. 6 is an illustration of the steps involved in the construction of the Hypogeal Battery.

### DETAILED DESCRIPTION OF THE INVENTION

It should be appreciated that while a preferred embodiment of the present invention will be described with reference to aluminum-ion electrochemical cell, other metal-ion electrochemical cells are also suitable for use in connection with the present invention. These include zinc-ion, iron-ion, magnesium-ion, lithium-ion, calcium-ion, sodium-ion, potassium-ion, and tin-ion electrochemical cells.

In accordance with a preferred embodiment, the present invention teaches the storage of electricity using an electrochemical cell comprising a) a cylindrical exterior container; b) a coiled anodic wire; c) a graphite sheet cathode; d) a sandy electrolyte medium; and e) an electrolyte based on a mixture of urea, sea-salt, and water.

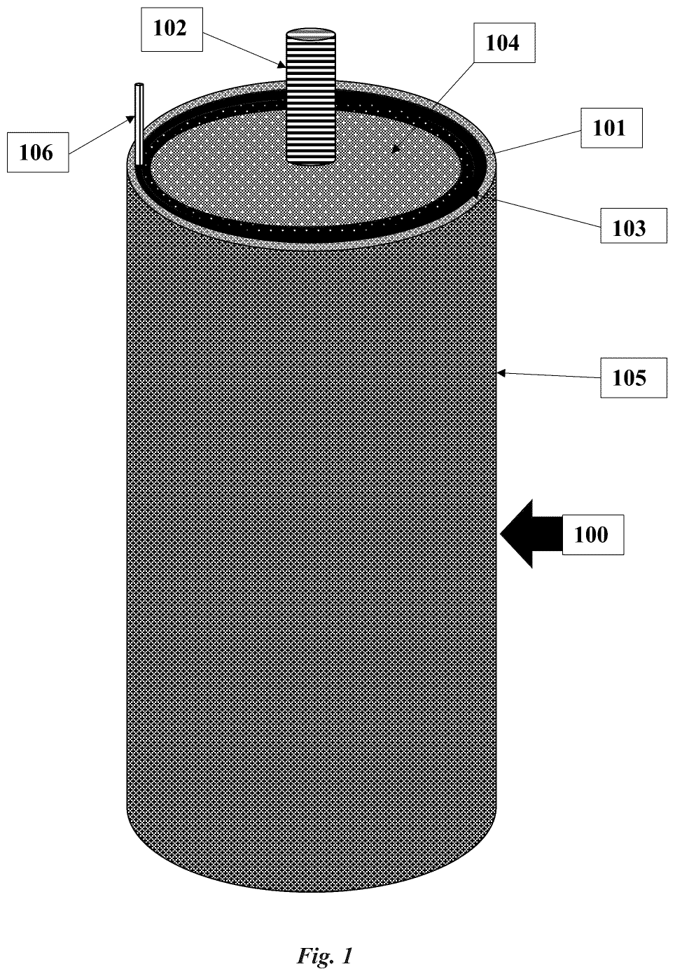

Referring now to the drawings wherein the showings are for the purposes of illustrating a preferred embodiment of the invention only and not for purposes of limiting same, FIG. 1 is an illustration of the isometric view of sandy rechargeable cell 100 with air cathode 101, anode 102, and exterior container 106.

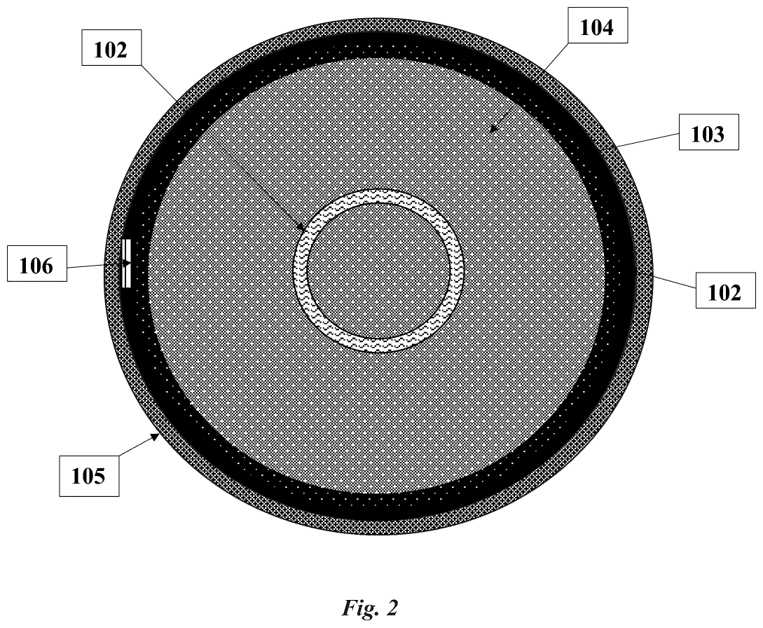

Referring now to FIG. 2:
1. Cathode 101. According to the preferred embodiment of this patent, cathode 102 consists of a folded graphite sheet.
2. Anode 102. According to the preferred embodiment of this patent, anode 102 is a single coiled pure aluminum wire (Gauge: 9-18). The tip end of anodic aluminum wire 102 serves as the negative terminal for sandy rechargeable cell 100.
3. Current Collector 103: According to the preferred embodiment of this patent, current collector 103 consists of a composite material made of copper mesh sandwiched between conductive copper foils.

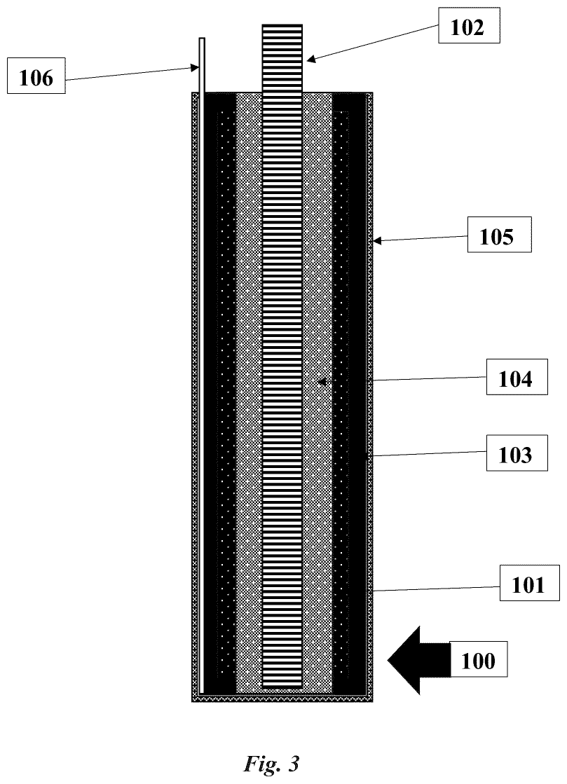

Referring now to FIG. 3:
1. Electrolyte Medium 104. According to the preferred embodiment of this patent, Anolyte Medium 104 consists of fine sand.
2. Exterior Container 105. According to the preferred embodiment of this patent, exterior container 105 consists of a plastic material.
3. Positive Terminal 106. According to the preferred embodiment of this patent, positive terminal 106 is a conductive metal connected to composite current collector 106. The preferred metal of choice is a nickel strip.

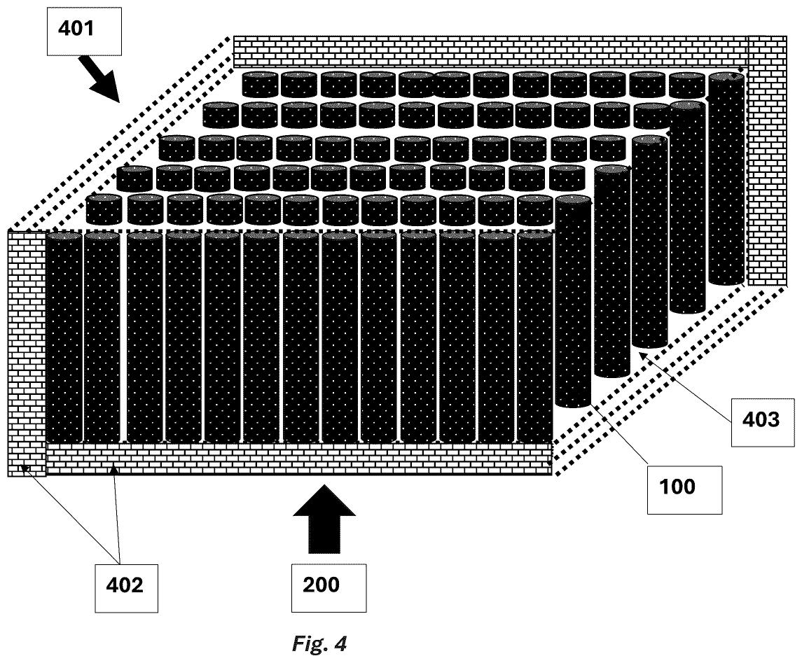

Referring now to FIG. 4:
1. Hypogeal Battery 200. According to the preferred embodiment of this patent, hypogeal battery 200 is built from a rectangular grid arrangement of sandy rechargeable cells 100. Hypogeal Electricity Generator 200 is built inside rectangular ditch 401 stabilized with concrete blocks 402 and lined with vapor barrier 403.
2. Ditch 401. According to the preferred embodiment of this patent, ditch 102 consists of rectangular excavated cavity in the ground.
3. Concrete Blocks 402. According to the preferred embodiment of this patent, concrete blocks 402 consist of standard-size rectangular blocks used in building construction.
4. Vapor Barrier 403. According to the preferred embodiment of this patent, vapor barrier 403 consists of a plastic sheet capable of resisting the diffusion of moisture through the walls or floor of ditch 401.

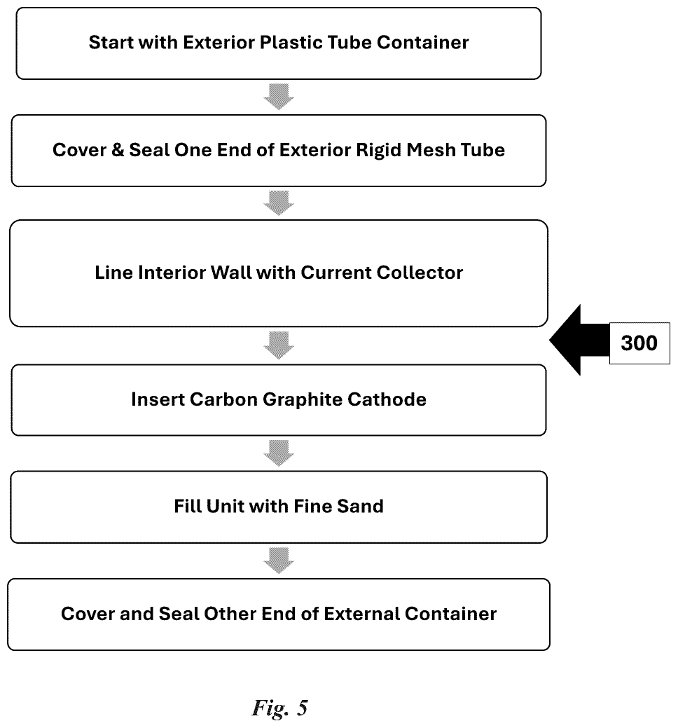

Referring now to FIG. 5, the steps 300 involved in the construction of the Sandy Rechargeable Cell 100 are:
Start with Exterior Plastic Tube Container 105
Cover & Seal One End of Exterior Plastic Tube 105
Line Interior Wall with Current Collector 103
Insert Carbon Graphite Cathode 101
Fill Anodic Medium 104 with Fine Sand
Cover and Seal Other End of External Container 105

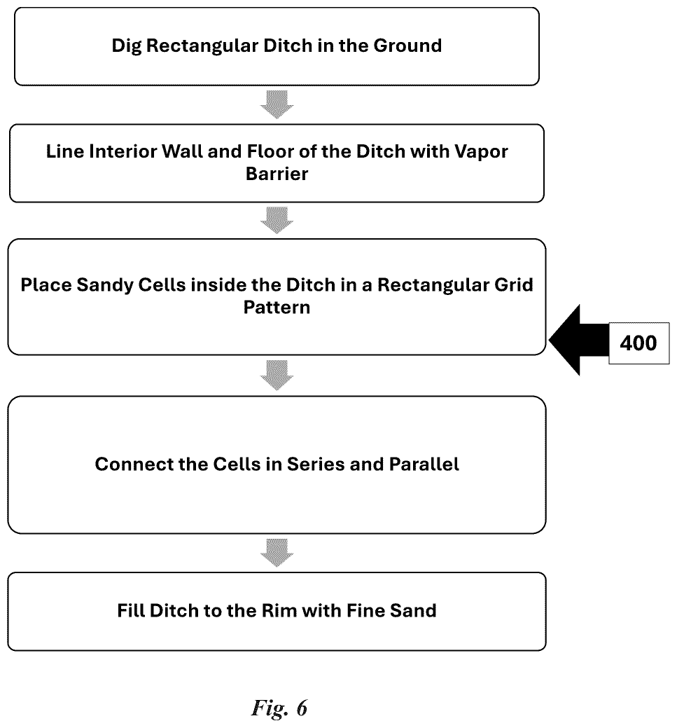

Referring now to FIG. 6, the steps 400 involved in the construction of Hypogeal Electricity Generator 200 are:
Dig Rectangular Ditch 401 in the Ground
Stabilize the Walls and Floor with Concrete Blocks
Line Interior Wall and Floor of Ditch 401 with Vapor Barrier 402
Place Sandy Cells 100 inside Ditch 401 in Rectangular Grid Pattern
Connect the Cells 100 in Series and Parallel
Fill Ditch 401 to the Rim with Fine Sand

### EXAMPLE

To establish the characteristics of the aluminum-ion electrochemical cell, according to the invention disclosed herein, charge and discharge tests were conducted on a cell of distinct size configurations, anodic coil, and cathodic carbon graphite sheet.
Exterior Container: Plastic Tube (Diameter: 50 mm; Length: 420 mm)
Anode: Cylindrical coil (Diameter: 16 mm; Height: 420 mm) made by spirally winding 2 mm (Gauge 12) aluminum wire.
Cathode: Graphite sheet (Width: 150 mm; Length: 420 mm)
Electrolyte: Solution of 35 grams of urea, 35 grams of sea-salt, and 1000 ml of water.
Electrolyte Medium: Fine sand.
Discharge current: 100 mA
Discharge test duration: 962 minutes
Current Capacity: 1,603 mAh
Energy Produced: 1,112 mWh
Open Circuit Voltage: 2.6V
Average Operating Voltage: 0.7V

The present invention has been described with reference to a preferred embodiment. Obviously, modifications and alterations will occur to others upon a reading and understanding of this specification. It is intended that all such modifications and alterations be included as far as they come within the scope of the appended claims or the equivalents thereof.

1. According to the present invention there is provided a method of storing electrical energy in the ground using ensemble electrochemical cells each comprising an exterior container, an anode, a cathode, a current collector, an electrolyte medium, and an electrolyte.

2. A method according to claim 1, wherein the electrochemical cell is membrane free.

3. A method according to claim 1, wherein the cathode consists of carbon graphite sheet.

4. A method according to claim 2, wherein the graphite sheet is folded.

5. A method according to claim 1, wherein the anode consists of an aluminum wire.

6. A method according to claim 5, wherein the anodic wire is shaped into a cylindrical coil.

7. A method according to claim 1, wherein the electrolyte medium consists of fine sand.

8. A method according to claim 1, wherein the electrolyte is a compound mixture of urea, sea-salt, and water.

9. A method according to claim 1, wherein the current collector consists of a composite material made of copper mesh sandwiched between conductive copper foils.

10. A method according to claim 1, wherein sandy rechargeable electrochemical cells are connected in series and parallel and placed inside a rectangular ditch excavated in the ground to form a hypogeal battery.

11. A method according to claim 10, wherein the rectangular ditch is pre-lined with rectangular concrete blocks and vapor barrier.
